(19) United States
(12) Patent Application Publication
(10) Pub. No.: US 2005/0097791 A1
(43) Pub. Date: May 12, 2005

(54) Keepsake system

(76) Inventor: Lisa M. Guadagno, Manalapan, NJ (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/705,049

(22) Filed: Nov. 10, 2003

(51) Int. Cl. G09F 19/12

(52) U.S. Cl. 40/427

(57) ABSTRACT

A keepsake system includes a platform and a plurality of media removably connected to the platform. Each media has a portion for recording a message such that the media can be removed to record a message. The media, having messages recorded thereon, are replaced by coupling the media to the platform to form a keepsake item.

### BACKGROUND OF THE INVENTION

1. Field of the Invention

The present invention relates to a keepsake system, and more particularly to a system and method for providing and maintaining sentiments on a keepsake item.

2. Description of the Related Art

To convey sentiment to others for holidays and special occasions many people have used stationary cards and gift cards. These prewritten cards are often merely signed by the sender without expressing original thoughts or conveying individualized sentiment from the sender. In most circumstances, the cards are kept for a period of time and then discarded.

It would be advantageous to provide a system and method for preserving the individual sentiments in a keepsake item.

### SUMMARY OF THE INVENTION

A keepsake system includes a platform and a plurality of media removably yet securely connected to the platform. Each media has a portion for recording a message such that the media can be removed to record a message. The media, having messages recorded thereon, are replaced by coupling the media to the platform to form a keepsake item.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a perspective view of a keepsake system in accordance with one illustrative embodiment of the present invention;

FIG. 2 is a perspective view of another keepsake system showing more detail in accordance with another illustrative embodiment of the present invention;

FIG. 3 is a side view of a keepsake system where pieces or media form a platform in accordance with another illustrative embodiment of the present invention;

FIG. 4 is a side view of the keepsake system of FIG. 3 where pieces have been removed in accordance the present invention;

FIG. 5 is a side view of the keepsake system of FIG. 4 where pieces have been written on or recorded on in accordance the present invention; and

FIG. 6 is a side view of the keepsake system of FIG. 5 where pieces have been reassembled to form a keepsake item in accordance the present invention.

### DETAILED DESCRIPTION OF PREFERRED EMBODIMENTS

The present invention provides a keepsake, which stores sentiments of individuals. The keepsake is maintained in a format, which is capable of display as a centerpiece or a conversation piece. For example, in one embodiment, the present invention includes an arrangement, which can be disassembled, have sentiments written or attached to pieces of the arrangement and then be reconstructed to provide a keepsake item having personalized sentiments preserved thereon.

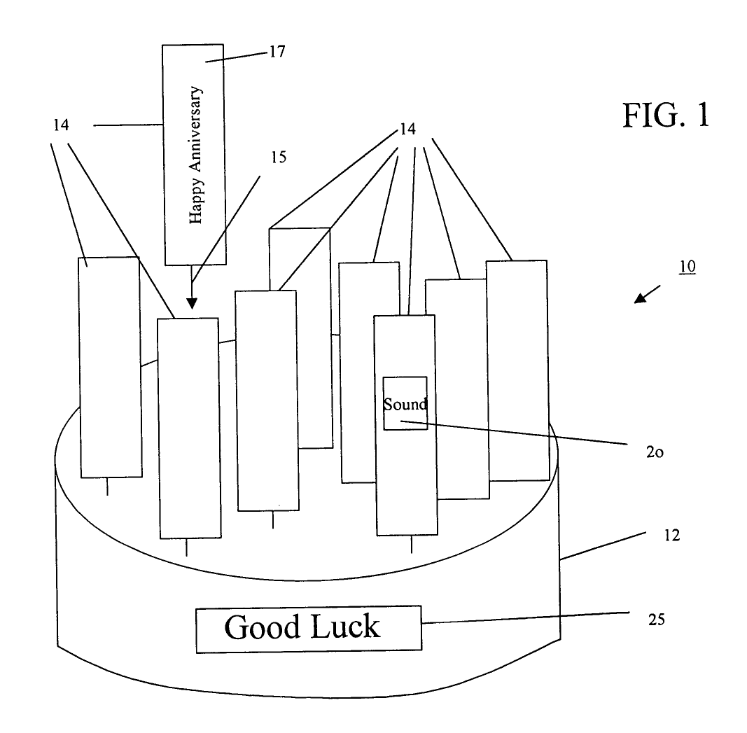

Referring now in detail to the figures in which like numerals represent the same or similar elements and initially to FIG. 1, a keepsake system 10 is illustratively shown in accordance with one embodiment of the present invention. System 10 includes a platform 12, which may include any material, which can be adapted to receive one or more inscribable or writable medium or media 14. The platform 12 may include pre-formed spaces therein that can accept media 14.

In one embodiment, platform 12 may include a soft or porous material, which is capable of receiving media 14. In one example, platform 12 includes a solid foam material and media 14 may include a sticking pin 15 attached to a label portion 17 of each media 14. Sticking pin 15 is received in foam material of platform 12 to maintain media 14 in a fixed position.

Initially, platform 12 includes a plurality of media 14 received therein. During an event, such as a party, gathering or other occasion, attendees are able to remove media 14 from platform 12. Media 14 is capable of being altered in a way to record individual sentiment thereon. For example, media 14 may include a material which can be written on, inscribed, painted, stamped otherwise altered by a guest or attendee of the event. After altering media 14, the attendee returns media 14 to platform 12. In this way, system 10 is reassembled to provide a keepsake, which records the sentiment of a plurality of attendees. The keepsake is suitable for display, for example, as a centerpiece or conversation piece in a residence or business.

The present invention will now be described in terms of applications of the present invention. These applications are for illustrative purposes only, and should not be construed as limiting the invention. One skilled in the art, upon review of this disclosure would understand how to apply the present invention and create a plurality of different variations within the scope of the present invention.

A keepsake in accordance with the present invention may include inscribable, personalizable items, which permit attendees or guests of an event to record their sentiments, advice or wishes to the item. As described with respect to FIG. 1, media 14 may include a material, which can be written on, for example, paper, wood, or other material. In other embodiments, media 14 may include a sound recordable chip 20, which can enable a user to make a sound recording, which can be stored on the media item 14 and replaced in platform 12 to be retrieved at a later time.

System 10 may be used for any social gathering, family occasion, an individual accomplishment, milestone event, holidays, etc. People can make use of media 14 to be able to convey any type of message including, but not limited to advice, good luck, best wishes for occasions, such as a birthday, a religious milestone, a wedding, mother's/father's day, a holiday, a corporate event, etc.

Advantageously, the media 14 and platform 12 may be formed in any shape or size and may preferably provide a thematic statement for a given event. For example, for a baby shower, platform may be formed into a crib with a mattress and media 14 may be in the form of a baby bottle or toy. In another example, for an anniversary, the platform 12 may be in the form of the number of the anniversary (for example 50^{th}) and the media 14 may include a plurality of different photographs of the individuals celebrating the anniversary. In yet another example, for a birthday, the platform 12 may be in the form of a cake and the media 14 may be in the form of different colored candles. In still other examples, a party may include a beach theme, the platform 12 may be in the form of an island or beach and the media 14 may be in the form of different sea creatures or beach related items.

Platform 12 may include a label or tag 25 describing the event or having the names of an honoree(s), etc.

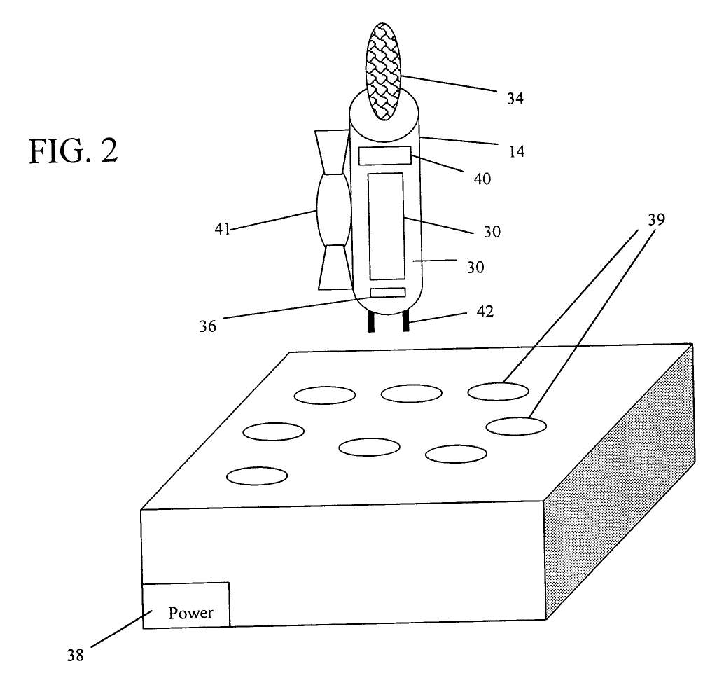

Referring to FIG. 2, in one illustrative embodiment, media 14 may be two-dimensional or three-dimensional items and may include a writable portion 30 and a non-writable portion 32. Media 14 may include lights 34, sound chips or other sound producing devices 36, or other novelty items and/or effects.

In one embodiment, platform 12 may include any material including but not limited to, foam, cardboard, papier maiche, polyresin, or other suitable materials. Platform 12 may include a power source 38, such as a battery or a connection to a wall outlet for electrical power. Media 14 may be energized via electrical or optical connectors 39 through platform 12. For example, a light 34 may be lit on media 14 when a connected to platform 12, or media 14 may include an optical wave-guide, which radiates light when connected or contacted with platform 12.

Media 14 and platform 12 form a decorative assembly, which can be personalized for specific occasions. Upon reinsertion of media 14 in platform 12 after inscribed by attendees, system 10 provides an even more personalized keepsake since it includes the sentiments of the attendees and even may keep track of the attendees. In one embodiment, the media 14 are each designated to an attendee or group of attendees. The media 14 may include information 40, such as the name of the attendee, a seating assignment for that attendee, a business card of the host, etc.

In addition, other items 41 may be attached to media 14. For example, candy, business cards, novelty items, magnets, with e.g., a corporate logo or information, a compact disk, a pen or pencil, etc. System 10 may be employed as a gift card, guest sign-in book, centerpieces or an individual gift from several people to one person or one person to another.

Media 14 form or shape can be of any related theme to the event such as, but not limited to champagne glasses, baby bottles and carriages, numbers, letters, etc. The material used for media 14 may include a thick card stock, plastic, metal, wood, etc. and can be written on and attached to a stem or other attachment device 42, such as a popsicle stick, toothpick, magnet, mechanical connector, snap, peg and slot connectors, etc. that can be connected to platform 12.

In one example, for a wedding or anniversary, platform 12 may be in the form of a wedding cake with several tiers and decorations. The guests attending the wedding remove a media item 14 from the cake, write a special wish for the bride and groom and place the media item back into platform 12. For a special birthday, platform 12 may be in form of a hill or small mountain and titled “Over the Hill”, and the media 14 are placed in the hill creating a “Mountain of Advice” for the person celebrating. For a baby shower, platform 12 may be circular with a flat base and placed in a basket titled “Bundle of Advice”. On mother's day the children or grandchildren can each remove a tag from platform 12, designed to be placed in a flower pot, etc. and write a special wish to Mom or Grandma and system 10 may be given as a gift already filled out by the special people in their life. The number of media items 14 may be adjusted depending on the amount of people attending a party or giving system 10 as a gift.

Platform 12 may be adapted to fit inside an item, for example, a helmet, flowerpot, lunch box, pail or other container to provide an additional thematic impression or functional feature.

More examples include:
for retirement parties, system 10 can be designed for a golf type theme or for example for a police officer retirement; badges may be employed as media 14;
for New Year's Eve parties, system 10 may be employed to have all of the guests write their resolution and re-insert into platform 12, and media 14 may include noise makers or the like;
for mother's day, system 10 may be employed to have a gift flower pot as a platform 12 with the flower inserts for media 14 filled out by all of the children and or grandchildren, and given as a creative and personalized gift.

Other applications include a teacher gift from the entire class, a coach gift from the team, sweet 16's (advice, congrats or replace the old guest sign in books for all parties listed), Bar/Bat Mitzvah's, Communion, Confirmation, get well soon (well wishes), congratulations on your new job, bridal/baby shower, going away party, house warming, bachelor/bachelorette parties, holiday's, for example, Christmas, etc.

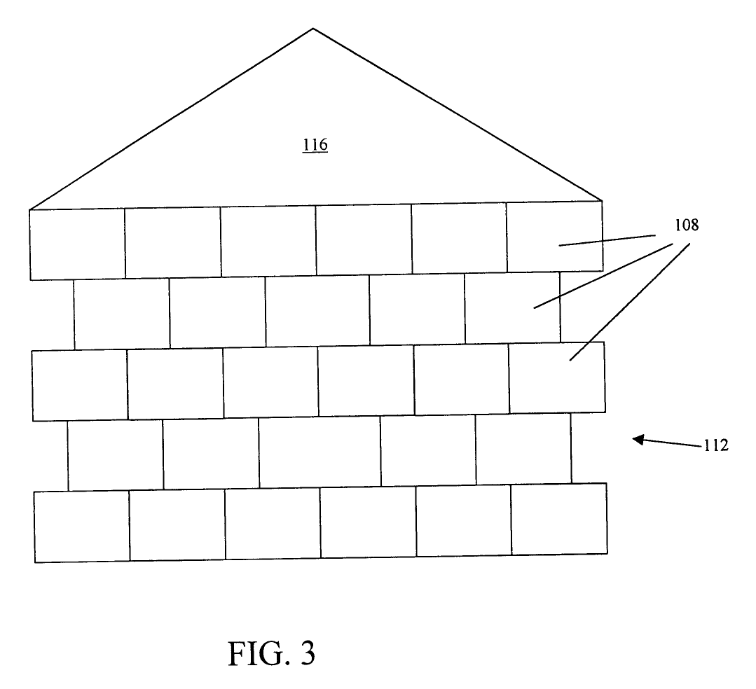

Referring to FIG. 3, a three-dimensional platform 112 in the form of a castle is illustratively shown. Platform 112 includes a plurality of interlocking or fitted pieces 108. Pieces 108 function as described above with respect to media 14, and once assembled the media/pieces form the platform 112. Pieces 108 permit platform 112 to be disassembled to enable an attendee, guest, or member of a group write or otherwise record a message thereon. Platform 112 may include additional feature such as lights, speakers, animated/robotic figures, a waterfall, a windmill, etc. or include areas which store items, e.g., the center of platform 112 may be hollow and store candy or other items. Other decorative feature 116 may be included as well. In this case, a roof is provided as a feature 116.

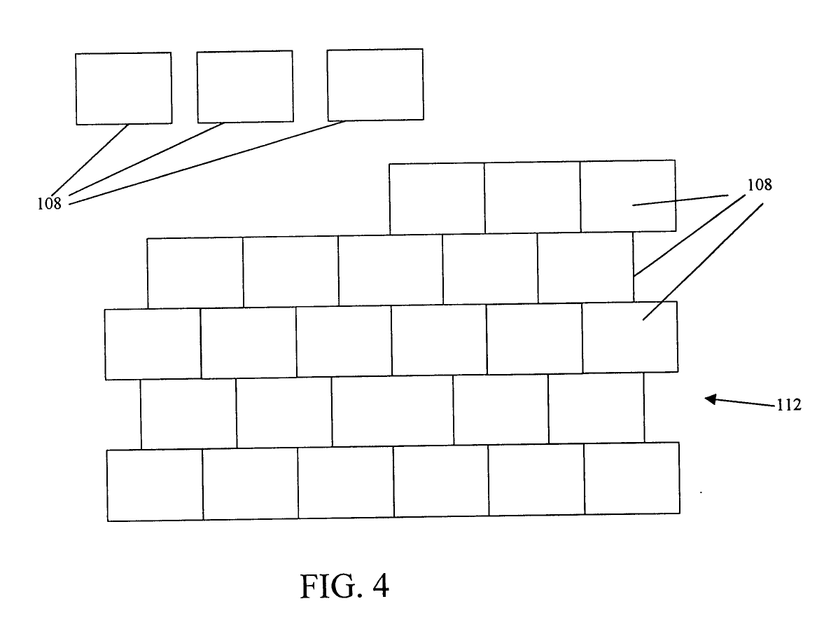

Referring to FIG. 4, during an event, roof 116 may be removed to permit access to pieces 108. Pieces 108 may be magnetically attached, may include mechanical interlocks (e.g., loop and hole, bristle block or snap together blocks) may simply be stacked or may include other features to receive and connect pieces 108 together. Pieces 108 may be formed from any suitable material including porcelain, plastic or polyresin, papier maiche, cardboard, paper, foam, etc.

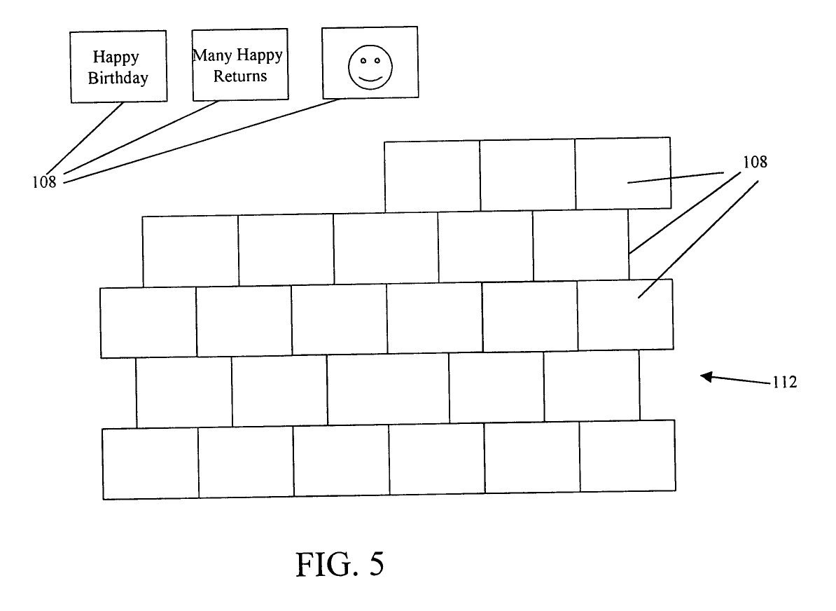

Referring to FIG. 5, pieces 108 are inscribed, stamped, painted, recorded on, or written on by the attendees or members and returned to platform 112.

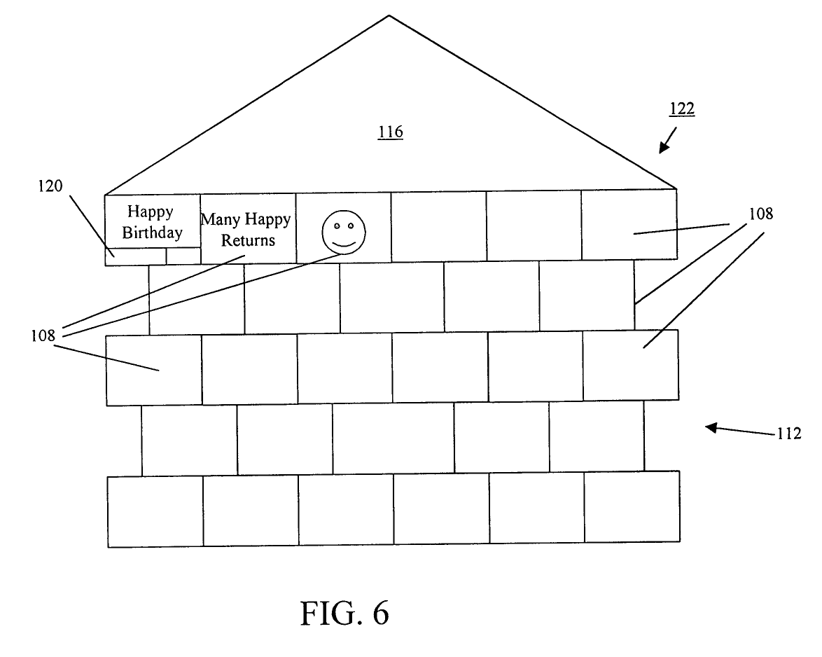

Referring to FIG. 6, pieces 108 may be the same size and shape or may be of different sizes and shapes. In the later case, the platform 112 is reassembled in a predetermined fashion to ensure that the reassembled platform 112 is properly constructed. In the former case, the block or pieces 108 can be placed anywhere in the design. Pieces 108 may be marked with a location or position where the piece 108 should be located. In this way, once all the pieces are returned the platform 112 can be reconstructed. Pieces 108 may also include other information 120, such as the name of the member or attendee who will write a message, etc. on a piece. In this way, the member or attendee can remove a piece designated for that member/attendee and once it is returned, the message would be credited to that member/attendee. Any additional features 116 are then restored to complete the reassembly of a keepsake 122 in accordance with the present invention.

Platform 112 and/or pieces 108 may form a plurality of different objects, for example, a statue, a vase or pottery, building or bridge, or any other suitable structure or form.

Having described preferred embodiments of a keepsake and method (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A keepsake system, comprising:
a platform;
a plurality of media removably connected to the platform, each media having a portion for recording a message such that the media can be removed to record a message, wherein the media having messages recorded thereon are replaced by coupling the media to the platform to form a keepsake item.

2. The system as recited in claim 1, wherein the platform and the media are related by a common theme.

3. The system as recited in claim 1, wherein the platform and the media are decorated based on a particular occasion or event.

4. The system as recited in claim 1, wherein the platform and the media form a three-dimension structure, which is employed as a centerpiece for a gathering.

5. The system as recited in claim 1, wherein the media form the platform.

6. The system as recited in claim 1, wherein the media are staked into the platform.

7. The system as recited in claim 1, wherein the platform includes a power source and the media are energized through the platform.

8. The system as recited in claim 7, wherein the media are energized to light up or carry light.

9. The system as recited in claim 1, wherein the media include information, the information including at least one of a position for reassembly of the media, or a name of a person.

10. The system as recited in claim 1, wherein the media include gift items attached thereto.

11. A keepsake system, comprising:
a plurality of pieces removably connected to form a structure, each media having a portion for recording a message such that the pieces can be removed to record a message, wherein at least the pieces having messages recorded thereon are assembled to form a keepsake item.

12. The system as recited in claim 11, wherein the system has a form related to an event or occasion.

13. The system as recited in claim 11, wherein the system forms a three-dimension structure, which is employed as a centerpiece for a gathering.

14. The system as recited in claim 11, wherein the pieces have different sizes and shapes.

15. The system as recited in claim 11, wherein the pieces interlock to remain together.

16. The system as recited in claim 11, further comprising a power source, which energizes at least one of a light or a speaker.

17. A method for providing a keepsake gift, comprising the steps of:
providing a platform and a plurality of media removably connected to the platform;
providing the media with a portion for recording a message such that the media can be removed to record a message; and
making the media with reattachable to the platform such that the media having messages recorded thereon can be replaced on the platform to form a keepsake item.

18. The method as recited in claim 17, wherein the platform and the media are related by a common theme.

19. The method as recited in claim 17, wherein the media form the platform.

20. The method as recited in claim 17, further comprising the step of providing the media with at least one of information and gift items.
